(19) United States
(12) Patent Application Publication
(10) Pub. No.: US 2006/0231124 A1
(43) Pub. Date: Oct. 19, 2006

(54) Substrate processing method

(75) Inventors: Hiroshi Watanabe, Tokyo (JP); Tamotsu Mezaki, Tokyo (JP); Shigeru Kido, Kanagawa (JP); Kiyofumi Sakaguchi, Kanagawa (JP)

Correspondence Address: FITZPATRICK CELLA HARPER & SCINTO, 30 ROCKEFELLER PLAZA, NEW YORK, NY, 10112, US

(73) Assignees: Chemical Art Technology Inc., Atsugi-shi (JP); Cannon Kabushiki Kaisha, Tokyo (JP)

(21) Appl. No.: 11/433,616

(22) Filed: May 15, 2006

Related U.S. Application Data
(62) Division of application No. 10/619,576, filed on Jul. 16, 2003.

(30) Foreign Application Priority Data
Jul. 16, 2002 (JP) 2002-207405(PAT.)
Dec. 10, 2002 (JP) 2002-357985(PAT.)
Jun. 13, 2003 (JP) 2003-169819(PAT.)

(51) Int. Cl. B08B 3/00

(52) U.S. Cl. 134/26; 134/31

(57) ABSTRACT

Provided is a processing method capable of reliably processing the inside of a depression such as a trench, a contact hole, a deep pattern, or a pore of a porous substrate. A chemical solution M is supplied into a processing bath 1 placing a substrate W, and the processing bath 1 is repetitively evacuated and pressurized several times at a pressure lower than the atmospheric pressure. Alcohol X is brought into contact with the surface of the substrate W and supplied into a depression W−1. The chemical solution M is supplied into the processing bath 1 containing the substrate W until the chemical solution M reaches a water level at which the substrate W is dipped, thereby allowing the chemical solution M to enter the depression W−1. The chemical solution M is discharged from the processing bath 1, and a portion of the chemical solution M entering the depression W−1 and mixed with the alcohol X is evaporated by evacuating the processing bath 1. This process is repeated several times.

This application is a division of application Ser. No. 10/619,576, filed Jul. 16, 2003, which is incorporated herein by reference.

### FIELD OF THE INVENTION

The present invention relates to a substrate processing method and substrate processing apparatus and, more particularly, to a substrate processing method and substrate processing apparatus suited to processing a substrate having fine depressions.

### BACKGROUND OF THE INVENTION

In semiconductor device fabrication, a cleaning process and low pressure drying process are successively performed in some cases to clean the surface of a substrate such as a wafer. In the cleaning process, a chemical treatment is performed to etch away oxide films, contaminants, and the like by using a chemical solution such as a hydrofluoric acid (HF) solution. Subsequently, a washing process is performed to wash away deposits such as the chemical solution and etching residue (organic or inorganic residue) sticking to the substrate by using pure water such as hot water or cold water.

Also, examples of porous substrate processing are a process of removing foreign objects sticking to pores of a porous substrate with pure water while applying ultrasonic energy (Japanese Patent Laid-Open No. 10-64870/Japanese Patent No. 3192610), and a process of removing foreign objects sticking to pores of a porous substrate by using a cleaning solution prepared by adding alcohol to pure water (Japanese Patent Laid-Open No. 2000-277479/Japanese Patent No. 3245127).

The surface of a substrate can have various complicated depressed structures, such as trenches, contact holes, and deep patterns, having a line width of 10 μm or less and different depths. Also, in the surface of a porous substrate, a large number of pores or depressions having a pore size of about a few nm to a few hundred nm are present in a depth of a few μm to a few hundred μm.

In the conventional wet processing method, a processing solution such as a chemical solution or pure water sometimes does not reliably enter deep in a depression due to the interference caused by the surface tension (contact angle) determined by the type of the processing solution and the contact surface (material) or the interface by an air bubble in the depression. The smaller the size of a trench, the less easily a liquid is supplied deep in a depression (“Silicon Wafer Surface Cleaning Technique New Edition” edited and written by Takeshi Hattori, 2001, issued by Realize Inc., page 454, right column, lines 1 to 16).

At present, this lowers the reliability of the series of cleaning processes such as the chemical treatment of etching away oxide films, contaminants, and the like in depressions by a chemical solution, and the washing process of washing away impurities and etching residues with pure water.

Depending on the material of a depression or the type of processing solution, the processing solution may be supplied deep in the depression by the generated capillary force to fill the entire depression. Even in this case, however, the inside of the depression is sometimes not well cleaned.

This is so because the capillary force, i.e., the liquid penetration force generated in a depression such as a trench or pore is much stronger than the repulsive force of an air bubble entering and compressed in the depression, so the processing solution once entering the depression stays inside without going outside. That is, the processing solution cannot flow in the depression, and this leads to inferior cleaning.

As the performance and integration of semiconductor devices improve, the process of cleaning the inside of depressions such as trenches, contact holes, and deep patterns in semiconductor device fabrication is beginning to be regarded as important. Accordingly, it is an important subject for semiconductor manufacturers to improve cleaning techniques capable of reliably removing oxide films, contaminants, and the like in depressions. It is also important to reduce inferior cleaning of porous substrates.

The magnitude of the repulsive force of a compressed air bubble in a depression such as a trench and the magnitude of the liquid penetration force acting in the depression are presumably determined by the internal surface area of the depression, the surface tension of a processing solution such as a chemical solution or pure water, and the surface tension (contact angle) of the material of the depression. Therefore, the magnitudes of these forces cannot be easily specified.

Also, adsorption is easily produced on the surface of a substrate activated (completely dried) by the low pressure drying process performed after the final washing process. If this substrate is exposed to the atmosphere, contaminated atmospheric water (containing impurities and contaminants such as organic and inorganic components) is adsorbed in the surface of the substrate to form an adsorbed contaminated film on the surface.

If this adsorbed contaminated film is formed on the substrate surface, the water may enter depressions by the capillary force and contaminate the inside of these depressions. Accordingly, it is important to minimize contamination in the atmosphere.

Additionally, penetration of a processing solution such as a chemical solution or pure water into a depression changes in accordance with whether the material of the depression is hydrophilic or hydrophobic. For example, when the material of a depression is hydrophobic, no penetration of a liquid into a depression occurs at all in some cases if the depression has a line width of 10 μm or less and a complicated depth or shape.

A porous substrate can be formed by anodizing a semiconductor substrate such as a silicon substrate. Anodization can be performed by applying an electric field to a silicon substrate in a hydrofluoric acid (HF) solution. If the anodized silicon substrate is not sufficiently cleaned, HF components or HF byproducts may remain in pores to change the porous structure or cause secondary contamination.

### SUMMARY OF THE INVENTION

The present invention has been made in consideration of the above various problems, and has as its object to provide a substrate processing method and substrate processing apparatus suited to reliably and stably processing a substrate having depressions.

According to a first aspect of the present invention, there is provided a substrate processing method comprising a closing step of placing a substrate in a processing bath and closing the processing bath, and a pressure control step of changing an internal pressure of the processing bath with the substrate dipped in a processing solution. The pressure control step comprises an evacuation step of evacuating the processing bath.

According to a preferred embodiment of the present invention, the pressure control step comprises a pressurization step of pressurizing the processing bath after evacuation in the evacuation step.

According to another preferred embodiment of the present invention, the pressure control step comprises repeating a cycle including the evacuation step and pressurization step a plurality of number of times.

The pressure control step preferably comprises reducing the internal pressure of the processing bath to a pressure lower than the atmospheric pressure, and controlling the internal pressure of the processing bath within a pressure range lower than the atmospheric pressure.

According to a preferred application of the present invention, a substrate to be processed has a depression. In this case, the pressure control step preferably comprises changing the internal pressure of the processing bath such that an air bubble in the depression is released from the depression.

According to a preferred embodiment of the present invention, the substrate processing method of the present invention preferably further comprises a protective film formation step of forming a protective film on a processed substrate before the substrate is unloaded from the processing bath. The protective film is made of, e.g., pure water.

According to a second aspect of the present invention, there is provided a substrate processing method comprising an alcohol supply step of supplying alcohol to a substrate having a depression, a processing solution supply step of supplying a processing solution to the substrate, and allowing the processing solution to enter the depression, and an evaporation step of evaporating the alcohol and at least a portion of the processing solution in the depression, wherein a cycle including the alcohol supply step, processing solution supply step, and evaporation step is repetitively performed a plurality of number of times.

According to a preferred embodiment of the present invention, the alcohol supply step, processing solution supply step, and evaporation step are preferably performed by placing a substrate to be processed in a closed processing bath.

According to a preferred embodiment of the present invention, the substrate processing method of the present invention further comprises, after the processing solution supply step and before the evaporation step, a discharge step of discharging the processing solution from the processing bath.

The processing solution supply step favorably comprises supplying the processing solution to the processing bath such that a liquid level of the processing solution in the processing bath containing the substrate rises across a surface of the substrate. The processing solution is favorably supplied to the processing bath such that the liquid level of the processing solution rises at a rate of 0.001 to 1.0 m/s.

According to a preferred embodiment of the present invention, the alcohol supply step, processing solution supply step, and evaporation step can be performed at a pressure lower than the atmospheric pressure.

According to a preferred embodiment of the present invention, the substrate processing method of the present invention can further comprise a protective film formation step of forming a protective film on a processed substrate before the substrate is unloaded from the processing bath. The protective film is made of, e.g., pure water.

According to a third aspect of the present invention, there is provided a substrate processing apparatus comprising a closable processing bath for placing a substrate, and a pressure control mechanism for controlling an internal pressure of the processing bath, wherein the pressure control mechanism performs a cycle of evacuating and pressurizing the processing bath at least once while the substrate is dipped in a processing solution in the processing bath.

According to a preferred embodiment of the present invention, the pressure control mechanism so operates as to repetitively perform the cycle a plurality of number of times.

According to a preferred embodiment of the present invention, the pressure control mechanism so operates as to reduce the internal pressure of the processing bath to a pressure lower than the atmospheric pressure, and then control the internal pressure of the processing bath within a pressure range lower than the atmospheric pressure.

According to a preferred application of the present invention, the pressure control mechanism so operates as to control the internal pressure of the processing bath such that an air bubble in a depression of a substrate is released from the depression.

According to a fourth aspect of the present invention, there is provided a substrate processing apparatus comprising a closable processing bath for placing a substrate having a depression, an alcohol supply mechanism for supplying alcohol to the substrate in the processing bath, a processing solution supply mechanism for supplying a processing solution to the substrate in the processing bath, a discharge mechanism for discharging the processing solution in the processing bath to outside the processing bath, and a pressure control mechanism for evacuating the processing bath to evaporate the alcohol and at least a portion of the processing solution in the depression, wherein the alcohol supply mechanism, processing solution supply mechanism, discharge mechanism, and pressure control mechanism so operate as to repeat a plurality of number of times a cycle including supply of the alcohol by the alcohol supply mechanism, supply of the processing solution by the processing solution supply mechanism, discharge of the processing solution by the discharge mechanism, and evacuation by the pressure control mechanism.

The processing solution supply mechanism supplies the processing solution to the processing bath such that a liquid level of the processing solution in the processing bath rises across a surface of the substrate. The processing solution is favorably supplied to the processing bath such that the liquid level of the processing solution rises at a rate of 0.001 to 1.0 m/s.

Other features and advantages of the present invention will be apparent from the following description taken in conjunction with the accompanying drawings, in which like reference characters designate the same or similar parts throughout the figures thereof.

### BRIEF DESCRIPTION OF THE DRAWINGS

The accompanying drawings, which are incorporated in and constitute a part of the specification, illustrate embodiments of the invention and, together with the description, serve to explain the principles of the invention.

FIG. 1 is a view showing an outline of the arrangement of a processing system according to a preferred embodiment of the present invention;

FIGS. 2A and 2B are views showing an example of a (cleaning) process in a processing method according to the first embodiment of the present invention, in which FIG. 2A shows the state in which a closed processing bath is evacuated and a gas (air bubble) in a trench is expanded, and FIG. 2B shows the state in which a gas is supplied into the closed processing bath to pressurize, the processing bath, thereby compressing the gas in the trench;

FIG. 3 is a flow chart showing the procedure of the process according to the first embodiment of the present invention;

FIG. 4 is a flow chart showing a protective film formation process according to a preferred embodiment of the present invention;

FIGS. 5A to 5E are enlarged sectional views showing the movements of a gas (air bubble) and processing solution in a trench (depression) in the processing method according to the first embodiment of the present invention, in which FIG. 5A shows the state in which the processing solution supplied into a closed processing bath enters the trench by the capillary force, FIG. 5B shows the state in which the gas in the trench is expanded by evacuation of the bath and the processing solution overflows from the trench, FIG. 5C shows the state in which a portion of the gas overflowing from the trench is released into the processing solution, FIG. 5D is a view showing the state in which the gas in the trench is compressed by pressurization of the bath and the processing solution enters the trench, and FIG. 5E shows the state in which the gas in the trench is completely discharged and the processing solution enters deep in the trench;

FIG. 6 is a view showing the steps of a process according to the second embodiment of the present invention;

FIG. 7 is a flow chart showing the procedure of the process according to the second embodiment of the present invention;

FIG. 8 is a view for explaining the feature of a depression;

FIG. 9 is an enlarged sectional view showing the state in which a pure water adsorption film is formed on the substrate surface;

FIGS. 10A to 10F are enlarged sectional views showing the way a processing solution entering a trench and mixed with alcohol moves in the trench in the processing method according to the second embodiment of the present invention, in which FIG. 10A shows the state in which vapor of alcohol supplied into a closed processing bath enters the trench, FIG. 10B shows the state in which the processing solution supplied into the processing bath enters the trench while mixing with the alcohol, FIG. 10C shows the state in which the processing solution is discharged from the processing bath and the processing solution near the entrance of the trench starts evaporating together with the alcohol by evacuation of the bath, and FIGS. 10D to 10F show the state in which the evaporation of the processing solution in the trench gradually progresses;

FIG. 11 is a view showing the steps of a cleaning method according to the third embodiment of the present invention;

FIG. 12 is a flow chart showing the procedure of the process according to the third embodiment of the present invention; and

FIGS. 13A to 13E are enlarged sectional views showing the way alcohol and a processing solution mix with each other and enter a trench in the processing method according to the third embodiment of the present invention, in which FIG. 13A shows the state in which vapor of the alcohol supplied into a closed processing bath is condensed on the surface of a substrate, FIG. 13B shows the state in which the processing solution having a rising liquid level is mixed with the condensed alcohol on the substrate surf ace, FIG. 13C shows the state immediately after the surface tension of the alcohol closing the entrance of the trench is broken by the kinetic energy generated when the alcohol and processing solution dissolve, and the processing solution starts entering the trench while mixing with the alcohol, FIG. 13D shows the state in which the processing solution mixed with the alcohol further enters the trench, and FIG. 13E shows the state in which the processing solution mixed with the alcohol enters deep in the trench to completely fill it.

### DETAILED DESCRIPTION OF THE PREFERRED EMBODIMENTS

The present invention is suited to processing various forms of substrates, such as a glass substrate of a liquid crystal display device or photomask, a printed circuit board, a silicon wafer, a compound semiconductor, a semiconductor, element such as an LSI, and a porous substrate, by using a processing solution such as a chemical solution or pure water. The present invention is suited to a process (e.g., a cleaning process) for depressions such as trenches, contact holes, and deep patterns in the surface of a substrate, particularly, complicated depressions having a line width of 10 μm or less and various depths. The present invention is also suited to a process (e.g., a cleaning process) for a porous substrate having a large number of pores exposed to the surface.

When a closed processing bath is evacuated to a pressure lower than the atmospheric pressure, the volume of an air bubble in a depression such as a trench, contact hole, deep pattern, or pore increases by, e.g., a few times to a few tens of times in substantially inverse proportion to the evacuation amount. When the processing bath is pressurized, e.g., the internal pressure of the processing bath is returned to the original pressure after that, the air bubble is compressed to reduce its volume to ½ to 1/90. By using this gas volume change, it is possible to release an air bubble outside a depression or move a processing solution in a depression. This processing is suitable for various wet processes such as a chemical treatment and cleaning process for a substrate having depressions such as trenches, contact holes, deep patterns or pores having a dimension of 10 μm or less.

Preferred embodiments of the present invention will be described below with reference to the accompanying drawings.

### First Embodiment

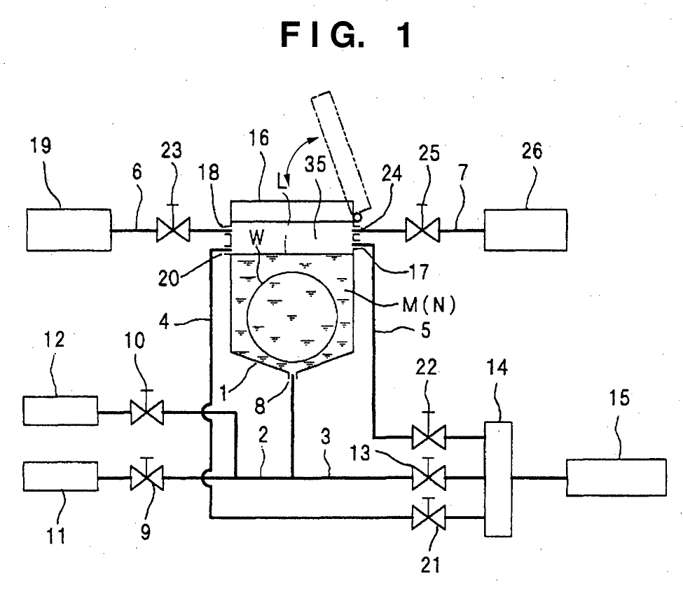

FIG. 1 is a schematic view showing the first embodiment of a processing system for performing a processing method of the present invention. Reference numeral 1 denotes a processing bath; 2, a liquid supply line; 3, a liquid discharge line; 4, an overflow line; 5, a suction line; 6, a gas line; and 7, a vapor supply line.

In the processing method of this embodiment, a substrate W is placed in the processing bath 1 which is to be closed. The substrate W can be set such that its surface is parallel to or oblique to the vertical direction. When a plurality of substrates W are to be processed at the same time, the substrates W can be arranged parallel.

Then, a chemical treatment of etching away oxide films and the like from the surface of the substrate W is performed by supplying a chemical solution M such as a hydrofluoric (HF) solution. After that, a washing process (rinsing process) of washing away the chemical solution M, deposits, and the like from the surface of the substrate W is performed by supplying pure water (rinsing solution) N such as hot water or cold water instead of the chemical solution M.

During the chemical treatment and washing process described above, pressure control by which the internal pressure of the processing bath 1 is reduced and increased is performed at least once, preferably, repeated a plurality of number of times. Consequently, the chemical treatment and washing process are reliably and effectively performed not only for the surface of the substrate W but also for the inside of depressions. This pressure control is useful in a process of, e.g., cleaning the inside of various complicated depressions, such as trenches, contact holes, or deep patterns, having a line width of 10 μm or less and different depths, or cleaning the inside of depressions such as pores of a porous substrate. During the chemical treatment and washing process, the internal pressure of the processing bath 1 is preferably controlled within a pressure range lower than the atmospheric pressure.

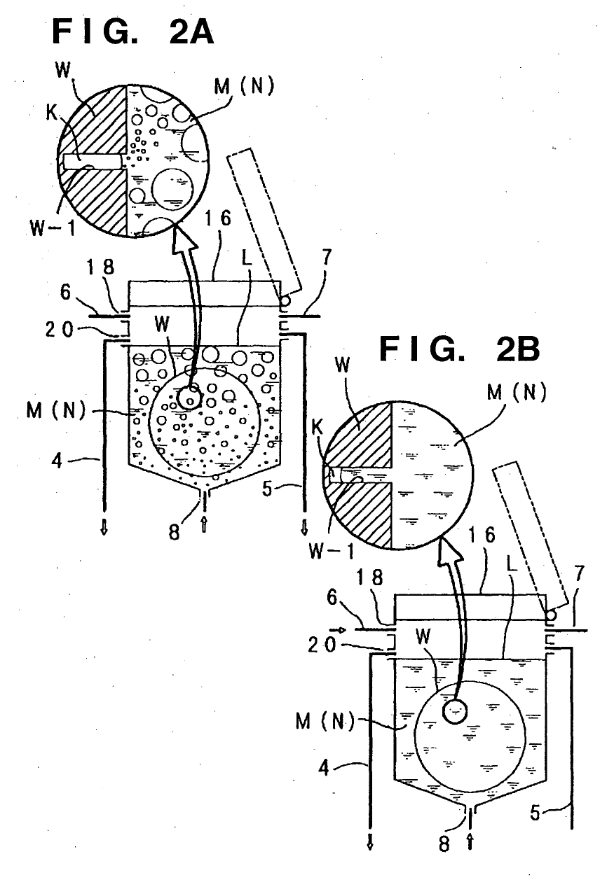

The processing performed for the substrate W and including the control of the internal pressure of the processing bath 1 will be described in more detail with reference to FIGS. 2A and 2B.

First, the substrate W is placed in the processing bath 1, and the processing bath 1 is evacuated to a pressure lower than the atmospheric pressure. After that, a processing solution (in this embodiment, the chemical solution M or pure water N) is injected into the processing bath 1. By thus evacuating the processing bath 1 to a pressure lower than the atmospheric pressure before the processing solution is injected into the processing bath 1, the processing solution can be supplied to the substrate W while the amount (the number of molecules) of gas in a depression W−1 such as a trench is reduced.

When the processing bath 1 is further evacuated, an air bubble K in the depression W−1 which opens to the surface of the substrate W expands in substantially inverse proportion to this evacuation amount (the difference between the pressure before evacuation and the pressure after evacuation). As schematically shown in FIG. 2A, most gas molecules forming the air bubble K overflow from the depression W−1. After that, the processing bath 1 is pressurized (its internal pressure is raised) (by, e.g., returning the internal pressure of the processing bath 1 to the original pressure), thereby compressing the air bubble K in the depression W−1. Consequently, as shown in FIG. 2B, the volume of the air bubble K reduces to, e.g., ½ to 1/90 (e.g., 1/2.5 to 1/50 in this preferred embodiment) the original volume of the air bubble K. This uses a volume change of the air bubble K (gas).

By the pressure control as described above, the processing solution such as the chemical solution M or pure water N can be brought into contact with the inner surfaces of the depression W−1 as well as the surface of the substrate W. Therefore, the depression W−1 can be reliably and efficiently cleaned as well as the surface of the substrate W.

During the chemical treatment and washing process described above, the internal pressure of the processing bath 1 is preferably within a pressure range lower than the atmospheric pressure as described above. Assuming that the pressure of complete vacuum is 0 kPa and the atmospheric pressure is 100 kPa, the internal pressure of the processing bath 1 is preferably 1 to 99 kPa, and more preferably, 30 to 99 kPa during the chemical treatment and washing process.

The internal pressure of the processing bath 1 can be controlled as follows. In the first stage, the internal pressure of the processing bath 1 is set to 30 to 99 kPa. In the subsequent second stage, the internal pressure of the processing bath 1 is further reduced to 2 to 70 kPa (lower than the pressure in the first stage. In the subsequent third stage, the internal pressure of the processing bath 1 is increased to 35 to 99 kPa (higher than the pressure in the second stage). The pressure in the third stage may also be substantially equal to that in the first stage. This cycle made up of the second stage (evacuation) and the third stage (pressurization) can be repetitively performed a plurality of number of times.

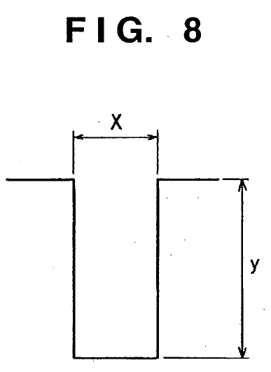

The depression W−1 can have various shapes and structures. When the depression W−1 is a trench, the depression W−1 typically has an aspect ratio y/x of 0.5 to 100, letting x and y be the width and depth of the depression, respectively, as shown in FIG. 8, and an entrance opening area of 0.01 μm or more.

The processing bath 1 can be, e.g., a pressure-resistant vessel which is made of quartz or a fluorine resin, or is obtained by forming a coating film made of a fluorine resin or the like on the surface of a metal plate. In the embodiment shown as an example in FIG. 1, the processing bath 1 has a size by which a large number of substrates W can be arranged parallel either vertically or obliquely. The processing bath 1 has a boxy shape having a hole in the upper portion and a bottom wall in the lower portion. The bottom wall inclines to a liquid supply/discharge port 8 formed in the center. The liquid supply line 2 and liquid discharge line 3 are connected to the liquid supply/discharge port 8 and branched.

The liquid supply line 2 is connected to a chemical supply unit 11 and pure water supply unit 12 via a chemical valve 9 and pure water valve 10, respectively, which are branched midway along the liquid supply line 2. Accordingly, the chemical solution M and pure water N can be supplied at a predetermined flow rate (m/s) from the liquid supply/discharge port 8 into the processing bath 1.

The liquid discharge line 3 is connected to a liquid discharge/vacuum suction unit 15 via a drain valve 13 and a header 14 connected to the end portion of the liquid discharge line 3. Therefore, after the chemical treatment or washing process, the chemical solution M or pure water N can be discharged by suction at a predetermined flow rate (m/s) from the processing bath 1.

Also, a lid 16 is attached to the upper opening of the processing bath 1 so as to be freely opened and closed. The processing bath 1 is closed by closing the lid 16. During the chemical treatment using the chemical solution M or during the washing process using the pure water N, the processing bath 1 is closed with the lid 16, and the internal pressure of the processing bath 1 is reduced to be lower than the atmospheric pressure. In addition, the processing bath 1 is evacuated (a vacuum is drawn) by the liquid discharge/vacuum suction unit 15 connected to a suction port 17 via the suction line 5, and pressurized (e.g., the original pressure is restored) by supply of a gas (e.g., N₂) by a gas supply unit 19 connected via a gas supply port 18 and the gas line 6. These evacuation and pressurization can be repetitively performed several times (N times).

An overflow port 20 which defines a liquid level L of the processing solution is formed in a side wall in the upper portion of the processing bath 1. The overflow port 20 is connected to the liquid discharge/vacuum suction unit 15 via the overflow line 4, an overflow valve 21, and the header 14 connected to the end portion of the overflow line 4. During the chemical treatment or washing process, therefore, the chemical solution M or pure water N which is supplied from the liquid supply/discharge port 8 into the processing bath 1 at a predetermined flow rate (m/s) and rises (floats) in contact with the surface of the substrate W overflows outside the processing bath 1 through the overflow port 20 from above the substrate W.

The suction port 17 is formed in a side wall in the upper portion of the processing bath 1. The suction port 17 is connected to the liquid discharge/vacuum suction unit 15 via the suction line 5, a suction valve 22, and the header 14 connected to the end portion of the suction line 5. This allows the closed processing bath 1 to be evacuated even during the chemical treatment washing process.

The gas supply port 18 is formed in a side wall in the upper portion of the processing bath 1. The gas supply port 18 is connected to the gas supply unit 19 via the gas line 6 and a gas valve 23. During the chemical treatment or washing process, therefore, the processing bath 1 can be pressurized through the gas supply port 18, e.g., the internal pressure of the evacuated processing bath 1 can be returned to the pressure before evacuation.

A vapor supply port 24 is also formed in a side wall in the upper portion of the processing bath 1. The vapor supply port 24 is connected to an alcohol supply unit 26 via the vapor supply line 7 and a vapor valve 25. After the substrate W is washed with the pure water N and the pure water N is discharged by suction at a predetermined flow rate (m/s) from the liquid supply/discharge port 8 in the bottom by the liquid discharge/vacuum suction unit 15, alcohol X such as vaporized isopropyl alcohol (IPA) is supplied by suction into the processing bath 1 at a pressure lower than the atmospheric pressure.

Preferred examples of the alcohol X other than isopropyl alcohol are methyl alcohol and ethyl alcohol.

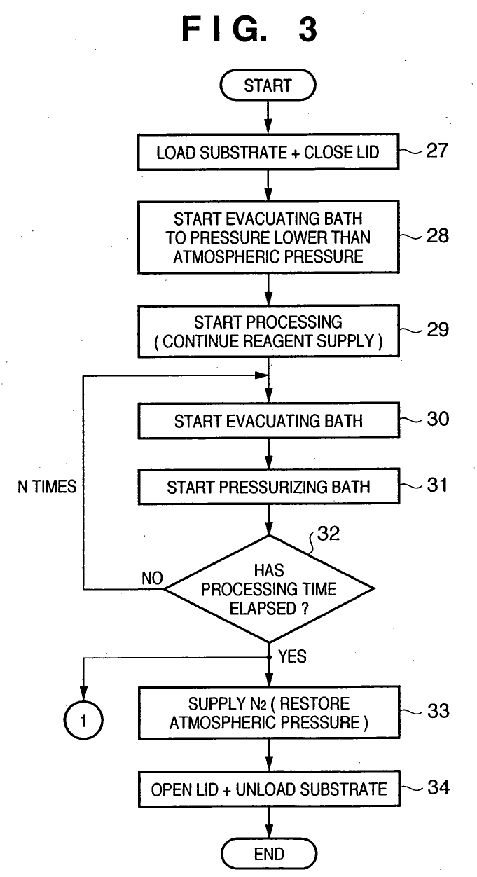

An example of the substrate processing method performed by the processing system shown in FIG. 1 constructed as above will be explained below with reference to a flow chart shown in FIG. 3.

Substrates W are loaded into the processing bath 1 and arranged parallel either vertically or obliquely, and the lid 16 is closed (step 27). In this step, the substrates W can be loaded into the processing bath 1 filled with the chemical solution M. It is also possible to load the substrates W into the empty processing bath 1 and supply the chemical solution M into the processing bath 1 after that. The following procedure is an example of the former.

After the lid 16 is closed, the liquid discharge/vacuum suction unit 15 is operated, and the suction valve 22 is opened, thereby starting an evacuation process of drawing a vacuum in the processing bath 1 to a pressure, e.g., 10 to 99 kPa, lower than the atmospheric pressure (step 28).

When the processing bath 1 is evacuated to a target pressure, e.g., 10 to 99 kPa, lower than the atmospheric pressure, the suction valve 22 is closed to stop the evacuating operation. Also, the overflow valve 21 is opened (the evacuating operation is stopped), the operation of the chemical supply unit 11 is started, and the chemical valve 9 is opened.

When the chemical valve 9 is opened, the chemical solution M is continuously supplied at a predetermined flow rate (m/s) from the liquid supply/discharge port 8 in the bottom into the processing bath 1 until the chemical valve 9 is closed. By this continuous supply of the chemical solution M, a rising flow of the chemical solution M which flows in contact with the surface of the substrate W is formed in the processing bath 1. The chemical solution M which rises to the liquid level L in the upper portion of the processing bath 1 shown in FIG. 1 overflows outside the processing bath 1 from the overflow port 20. This supply of the chemical solution M starts the chemical treatment of etching away oxide films, contaminants, and the like on the substrate W (step 29).

After a predetermined time has elapsed since the chemical treatment is started by the circulating supply of the chemical solution M, the suction valve 22 is opened to start an evacuating operation by which the internal pressure of the processing bath 1 is further reduced from a first pressure value of 10 to 99 kPa to a second pressure value (lower than the first pressure value) of 2 to 70 kPa (step 30).

After the internal pressure of the processing bath 1 lowers to the second pressure value within the range of 2 to 70 kPa, the suction valve 22 is closed (evacuation is stopped), the operation of the gas supply unit 19 is started, and the gas valve 23 is opened.

By opening the gas valve 23, a gas is supplied from the gas supply port 18 into the processing bath 1, and this starts a pressurizing operation which raises the internal pressure of the processing bath 1 from the second pressure value to a third pressure value (higher than the second pressure value, e.g., equal to the first pressure value) (step 31).

After the internal pressure of the processing bath 1 has reached the third pressure value (e.g., 85 to 99 kPa), the gas supply unit 19 is stopped, and the gas valve 23 is closed. Also, the suction valve 22 is opened, and the flow returns to step 30 in which the processing bath 1 is evacuated again. Evacuation in step 30 and pressurization in step 31 are repeated several times (N times).

When steps 30 and 31 are repeated a preset number of times (N times) and a predetermined processing time has elapsed within which the chemical treatment using the chemical solution M is completely performed not only for the surface of the substrate W but also for the depression W−1 such as a contact hole or deep pattern (YES in step 32), the chemical supply unit 11 and liquid discharge/suction unit 15 are stopped, and the chemical valve 9 and overflow valve 21 are closed.

When the substrates W are to be transferred to the next step after the chemical treatment of the substrates W by the chemical solution M is complete, the operation of the gas supply unit 19 is started, and the gas valve 23 is opened. Consequently, a gas is supplied into the processing bath 1 to return the internal pressure of the processing bath 1 to the atmospheric pressure (step 33).

When the internal pressure of the processing bath 1 is returned to the atmospheric pressure, the operation of the gas supply unit 19 is stopped, and the gas valve 23 is closed. In addition, the lid 16 in the upper portion of the processing bath 1 is opened, and the substrates W are unloaded from the processing bath 1 (step 34).

The substrates W can be unloaded with the chemical solution M in the processing bath 1 kept undischarged. Alternatively, the substrates W can be unloaded after the chemical solution M is discharged by suction through the liquid discharge line 3 from the liquid supply/discharge port 8 in the bottom of the processing bath 1 by operating the liquid discharge/vacuum suction unit 15 and opening the drain valve 13.

If the washing process using the pure water N is to be subsequently executed after the chemical treatment is completed, the chemical supply unit 11 is stopped, and the chemical valve 9 is closed. After that, the flow returns to step 29. In steps 29 to 31, the process is performed using the pure water N in place of the chemical solution M. More specifically, in step 29, the pure water supply unit 12 is operated, and the pure water valve 10 is opened to supply the pure water N from the liquid supply/discharge port 8 into the processing bath 1 at a predetermined flow rate (m/s), thereby replacing the chemical solution M with the pure water N. After that, steps 30 and 31 are repeated several times (N times) as in the chemical treatment described above.

When the washing process is to be performed by switching the chemical solution M to the pure water N, it is also possible to discharge the chemical solution M from the processing bath 1 and then supply the pure water N from the liquid supply/discharge port 8 into the processing bath 1.

In the processing method of this embodiment, after the substrate W is placed in the processing bath 1 and the processing bath 1 is closed, the processing bath 1 is evacuated to a pressure lower than the atmospheric pressure. This reduces the net gas amount (molecular weight) in the depression W−1 of the substrate W.

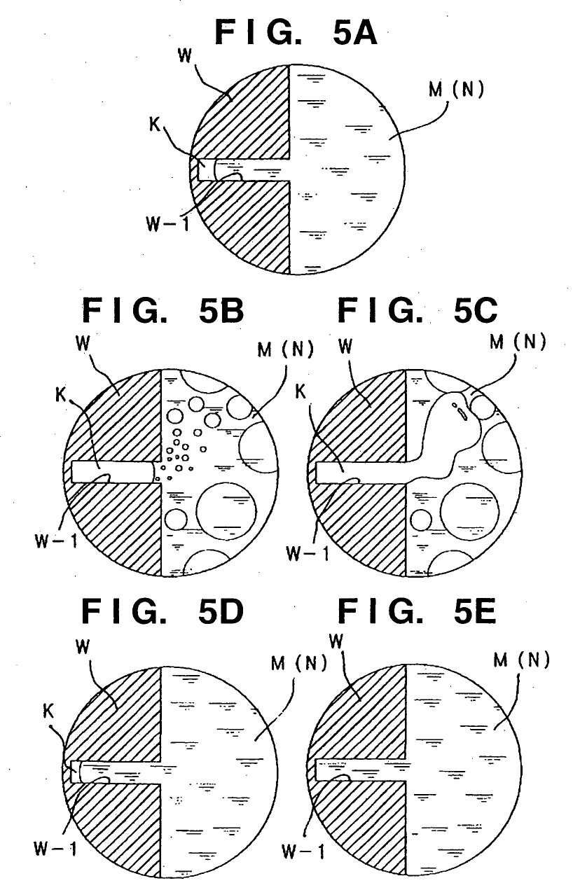

Also, when the internal pressure of the processing bath 1 is reduced during, e.g., the chemical treatment or washing process, the air bubble K entrapped in the depression W−1 in the surface of the substrate W dipped in the processing solution M expands (by, e.g., 2 to 50 times the original volume). As a consequence, a portion of the gas forming the air bubble K overflows from the depression W−1. This volume reduction will be schematically explained below. As the internal pressure of the processing bath 1 lowers, the air bubble K which is initially pushed in the depression W−1 by the capillary force, i.e., the liquid penetration force as shown in FIG. 5A expands as shown in FIG. 5B. As shown in FIG. 5C, a portion of the air bubble K overflows from the depression W−1 into the processing solution. This reduces the amount (the number of molecules) of the gas forming the air bubble K in the depression W−1. When the pressurizing operation is performed subsequently to the evacuating operation, as shown in FIG. 5D, the volume of the air bubble K reduces to ½ to 1/90 (e.g., 1/2.5 to 1/50) in substantially inverse proportion to the pressure.

When the evacuation and pressurization as described above are repeated, the gas forming the air bubble K in the depression W−1 is more reliably discharged outside the depression W−1.

Furthermore, in accordance with the increase/decrease in volume of the air bubble K as described above, the processing solution such as the chemical solution M or pure water N repeats the reciprocal motion (piston motion) in the depression W−1 (FIGS. 5A to 5D). Finally, the processing solution is completely supplied to the deepest portion of the depression W−1.

In the processing method of this embodiment as described above, pressure control by which the processing bath 1 is evacuated and pressurized is performed at least once, preferably, a plurality of number of times. Consequently, the air bubble K overflows from the depression W−1 by expansion, and the processing solution such as the chemical solution M or pure water N is allowed to enter the depression W−1 by compression of the air bubble K. In addition, the processing solution can be reciprocated in the depression W−1 by expansion and compression of the air bubble K. Accordingly, the depression W−1 can be reliably subjected to the chemical treatment and/or the washing process. This effect can be obtained regardless of the type of processing solution used in the wet processing.

In the processing method of this embodiment, therefore, the processing solution such as the chemical solution M or pure water N can be reliably supplied not only to the surface of the substrate W but also to the deepest portion of the depression W−1 such as various complicated contact holes or deep patterns having a line width of 10 μm or less and different depths, or pores of a porous substrate. Also, unnecessary materials in the depression W−1 can be discharged outside the depression W−1 by the reciprocal motion of the processing solution in the depression W−1. This makes it possible to reliably perform those series of cleaning processes from the chemical treatment using the chemical solution M to the washing process using the pure water N, which are important in the fabrication process of high-performance, highly integrated semiconductor devices. Similarly, these series of cleaning processes can also be reliably performed for pores of a porous substrate.

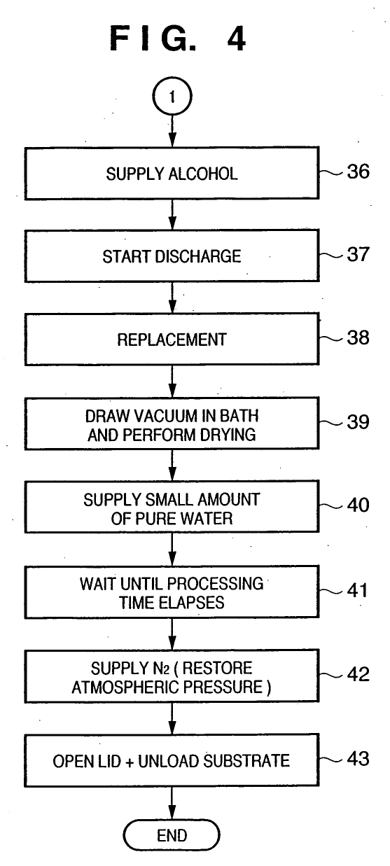

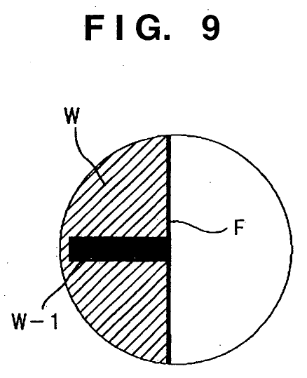

After the surface of the substrate W and the inside of the depression W−1 are finally washed with the pure water N and the pure water valve 10 is closed, a protective film F is favorably performed on the surface of the substrate W as illustrated in FIG. 9. The protective film 9 has an effect of preventing adsorption of contaminated water (e.g., water contaminated by organic components) in the atmosphere to the surface of the substrate W. For example, the protective film F can be formed in accordance with a flow chart shown in FIG. 4. The process of forming the protective film F will be explained below with reference to the flow chart in FIG. 4.

After the final washing process for the inside of the trench W−1 is completed and the pure water valve 10 is closed, the alcohol supply unit 26 is operated, and the alcohol valve is opened.

As a consequence, the vaporized alcohol X is supplied into a space 35 above the liquid level L in the processing bath 1 shown in FIG. 1, as the alcohol X is drawn from the vapor supply port 24 into the processing bath 1 (step 36). This supply of the alcohol X is continued until the space 35 above the liquid level L is filled with the vapor ambient of the alcohol X.

When the space 35 above the liquid level L is filled with the vapor of the alcohol X, the alcohol supply unit 26 is stopped, and the alcohol valve 25 is closed. After that, the liquid discharge/vacuum suction unit 15 is operated, and the drain valve 13 is opened to start discharging the pure water N from the liquid supply/discharge port 8 in the bottom of the processing bath 1 (step 37).

When discharge of the pure water N is started and the liquid level L begins to fall, the alcohol X supplied to the upper space 35 in the processing bath 1 comes in contact with the surface of the substrate W. By this contact, the alcohol X condenses to cause vapor replacement (mixed replacement) with water droplets sticking to the surface of the substrate W, and also causes vapor replacement with the liquid in the depression W−1. Consequently, the surface of the substrate W and the inside of the depression W−1 dry (step 38).

A vacuum is drawn in the processing bath 1 by the liquid discharge/vacuum suction unit 15 which is kept operated even after the pure water N in the processing bath 1 is completely discharged. By this evacuation, the alcohol X and humidity remaining on the surface of the substrate W, in the depression W−1, and in the processing bath 1 are forcibly exhausted (step 39). In this low pressure drying process, the vacuum degree in the processing bath 1 can be freely adjusted by intermittently operating the liquid discharge/vacuum suction unit 15, or by controlling the suction force of the unit 15.

In this process, it is also possible to open the suction valve 22 at the same time a vacuum is started to be drawn in the processing bath 1, thereby forcibly exhausting the alcohol X and humidity remaining in the processing bath 1 from the suction port 17 as well. As a consequence, the processing time of the low pressure drying process (step 39) can be reduced by, e.g., half.

When the low pressure drying process of the processing bath 1 by the liquid discharge/vacuum suction unit 15 is complete, the liquid discharge/vacuum suction unit 15 is stopped, and the drain valve 13 is closed. After that, the pure water supply unit 12 is operated, and the pure water valve 10 is slightly opened to supply a small amount of the pure water N from the liquid supply/discharge port 8 into the processing bath 1 (step 40). The pure water N is kept supplied until the processing bath 1 is filled with the vapor ambient of the pure water N.

The pure water N supplied into the processing bath 1 at a pressure lower than the atmospheric pressure is vaporized to form a film formation ambient in which a protective film F is formed on the surface of the substrate W in the processing bath 1.

Consequently, as shown in FIG. 9, the vaporized pure water N is adsorbed to the surface of the substrate W to form a protective film F of the pure water N on the surface.

At the same time, a portion of the pure water N adsorbed to the surface of the substrate W enters the depression W−1. Typically, the protective film F is a very thin film having a film thickness of 1 to 50 water molecules with which the film does not evaporate even if exposed to the atmosphere.

When a processing time necessary to form the projective film F on the surface of the substrate W has elapsed (step 41), the pure water valve 10 is closed. After that, the gas supply unit 19 is operated, and the gas valve 23 is opened to supply a gas into the processing bath 1, thereby returning the internal pressure of the processing bath 1 to the atmospheric pressure (step 42).

When the internal pressure of the processing bath 1 is returned to the atmospheric pressure, the gas supply unit 19 is stopped, and the gas valve 23 is closed. In addition, the lid 16 for closing the upper opening of the processing bath 1 is opened, and the substrates W each having the protective film F formed on it are unloaded from the processing bath 1 (step 43).

Accordingly, the substrate W which is cleaned by the chemical treatment and washing process by repeating evacuation and pressurization of the processing bath 1 at a pressure lower than the atmospheric pressure is protected from contaminants in the atmosphere of a clean room or the like by the protective film formed by the pure water N in the processing bath 1 after that.

That is, by forming the protective film F on the cleaned substrate W before the substrate W is unloaded form the processing bath 1, it is possible to prevent adsorption of contaminated atmospheric water (including organic contamination and the like) to the surface of the substrate W, and keep the substrate W clean even outside the processing bath 1.

To return the internal pressure of the processing bath 1 to the original pressure value (step 31) after the processing bath 1 is evacuated, or to return the internal pressure of the processing bath 1 to the atmospheric pressure (step 33 or 42) after the replacement drying process is performed by evacuation, the internal pressure of the processing bath 1 can be increased or returned the atmospheric pressure by using the following means instead of the N₂ gas supply means. For example, it is possible to use means for supplying into the processing bath 1 a humidity control gas which is mixed with pure water or the like and has humidity, or means for supplying into the processing bath 1 the air of the clean room after removing impurities and organic and inorganic components through a filter.

### Second Embodiment

The second embodiment of the processing system for performing the processing method of the present invention will be described below.

The processing system for performing this processing method has the same basic configuration as that of the processing system explained in detail in the first embodiment. Matters not particularly referred to in the second embodiment are the same as in the first embodiment.

In this processing system of the second embodiment, a suction port 17, suction line 5, and suction valve 22 are not always necessary. However, when a processing bath 1 is to be evacuated after a chemical solution M or pure water N in the processing bath 1 is discharged, the evacuation time can be shortened by performing suction from the suction port 17 in parallel with suction from a liquid supply/discharge port 8 in the bottom of the processing bath 1. Consequently, the bath can be efficiently evacuated within a short time period.

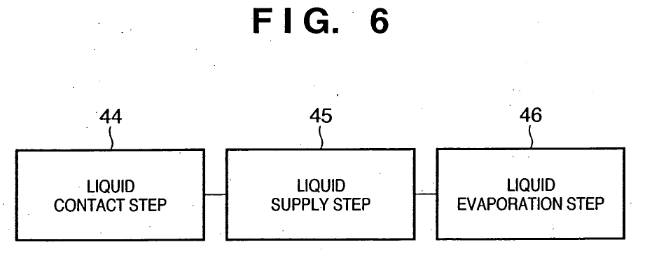

As shown in FIG. 6, the processing method of the second embodiment includes a liquid contact step 44, liquid supply step 45 and liquid evaporation step 46. The liquid contact step 44, liquid supply step 45, and liquid evaporation step 46 are performed at least once, preferably, repeated several times. By this processing, a chemical treatment and/or a washing process can be reliably performed not only for the surf ace of a substrate W but also for various complicated depressions, such as trenches, contact holes, and deep patterns, having a line width of 10 μm or less and different depths. Likewise, pores of a porous substrate can also be reliably cleaned.

In the liquid contact step 44, alcohol X such as isopropyl alcohol (IPA) is brought into contact with the surface of the substrate W and allowed to enter a depression W−1 in the surface. This facilitates supply of the chemical solution M or pure water N into the depression W−1 after that.

That is, the chemical solution M or pure water N alone cannot easily enter a depression such as a trench having a line width of 10 μm or less, because the surface tension (contact angle) of the chemical solution M or pure water N itself is an obstacle. In this embodiment, therefore, to allow the chemical solution M or pure water N to reliably enter the depression W−1, the alcohol X is brought into contact with (adhered to or condensed on) the surface of the substrate W.

Various methods are possible as a method of bringing the alcohol X into contact with the surface of the substrate W. For example, in the closed processing bath 1 in which substrates W are arranged parallel either vertically or obliquely, a vapor ambient of the alcohol X is formed, thereby bringing the alcohol X into contact with the surface of each substrate W and condensing the alcohol X on the surface. This method is desirably performed by making the internal pressure of the processing bath 1 lower than the atmospheric pressure.

In the liquid supply step 45, the chemical solution M or pure water N is supplied into the processing bath 1 containing the substrate W having the alcohol X which enters the depression W−1 in the liquid contact step 44, until the chemical solution M or pure water N reaches a liquid level L at which the substrate W is completely dipped. In this way, the chemical solution M or pure water N enters the depression W−1.

More specifically, while the chemical solution M such as a hydrofluoric acid (HF) solution or the pure water N which is hot water or cold water is supplied at a predetermined flow rate (m/s) from the liquid supply/discharge port 8 in the bottom of the processing bath 1, the chemical solution M or pure water N is allowed to overflow from an overflow port 20 formed in a side wall in the upper portion of the processing bath 1, thereby forming a rising flow in the processing bath 1. The chemical solution M or pure water N is used to perform a chemical treatment by which oxide films and the like on the substrate W are etched away, or a washing process by which deposits on the substrate W are washed away. During the chemical treatment or washing process, the chemical solution M or pure water N enters the depression W−1 while mixing with the alcohol X.

In the liquid evaporation step 46, the chemical solution M or pure water N is discharged from the processing bath 1 by suction. After that, a portion of the chemical solution M or pure water N mixed with the alcohol X in the depression W−1 is evaporated (volatilized) together with the alcohol X.

As a method of evaporating the chemical solution M or pure water N entering the depression W−1 together with the alcohol X, it is possible to, e.g., evacuate or heat the processing bath 1. In the following embodiment, the method of evacuating the processing bath 1 is used.

Accordingly, the chemical solution M or pure water N is allowed to enter the depression W−1 in the liquid supply step 45 described above, and the chemical solution M or pure water N is evaporated by evacuating the processing bath 1. When this cycle is repeated, movement (piston motion) of the liquid occurs in the depression W−1. By this movement, the chemical treatment and/or the washing process can be reliably performed for the depression W−1, so the inside of the depression W−1 can be cleaned as well as the surface.

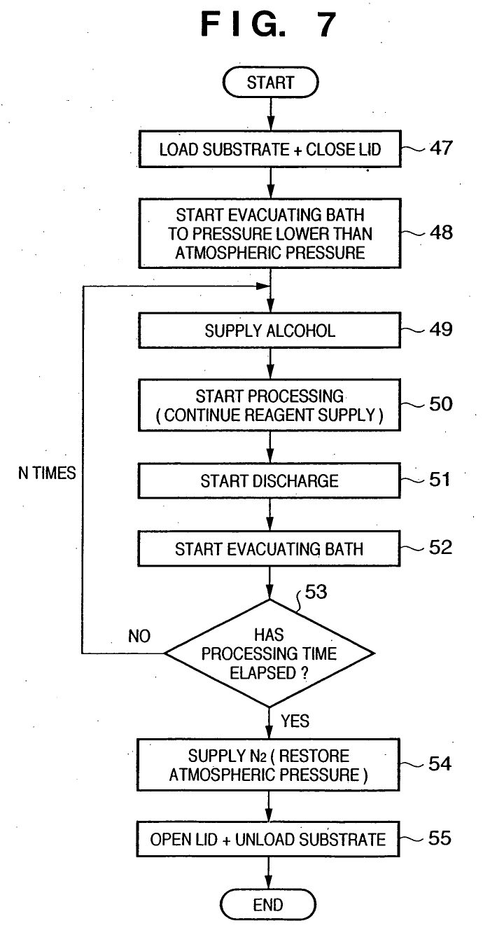

The processing method according to the second embodiment will be described below with reference to a flow chart shown in FIG. 7.

Substrates W are arranged parallel either vertically or obliquely in the processing bath 1, and a lid 16 is closed (step 47).

After the lid 16 is closed, a liquid discharge/vacuum suction unit 15 is operated, and a suction valve 22 is opened to start the process of evacuating the processing bath 1 to a pressure, e.g., 10 to 99 kPa, lower than the atmospheric pressure (step 48).

When the internal pressure of the processing bath 1 is reduced to the target pressure value within the range of 10 to 99 kPa, the suction valve 22 is closed. After that, an alcohol supply unit 26 is operated, and an alcohol valve 25 is opened. Consequently, vapor of the alcohol X generated by the alcohol supply unit 26 is supplied through a vapor supply line 7 and drawn into the processing bath 1 from a vapor supply port 24 in a side wall in the upper portion of the processing bath 1 (step 49). This forms a vapor ambient filled with the vapor of the alcohol X in the processing bath 1.

This supply of the alcohol X can be stopped when the vapor ambient is formed in the processing bath 1, or can be continued while the alcohol X is condensed on the surface of the substrate W by a temperature difference produced by contact with the surface and enters the depression W−1.

When the alcohol X filled in the processing bath 1 enters the depression W−1 such as a contact hole or deep pattern in the surface of the substrate W (in practice, when a time previously determined on the basis of experimental results and the like has elapsed), the alcohol valve 25 is closed, an overflow valve 21 is opened, a chemical supply unit 11 is operated, and a chemical valve 9 is opened. As a consequence, the chemical solution M is supplied from the liquid supply/discharge port 8 into the processing bath 1 at a predetermined flow rate (m/s).

When the supply of the chemical solution M into the processing bath 1 is started, a rising flow of the chemical solution M which flows in contact with the surface of the substrate W is formed, and the chemical treatment by which oxides, contaminants, and the like on the substrate W are etched away is started. The chemical solution M rising in the processing bath 1 overflows from the overflow port 20 and is discharged through the overflow valve 21. The chemical solution M enters the depression W−1 while mixing with the alcohol X in the depression W−1, and chemically treats the inside of the depression W−1 (step 50).

When a predetermined time has elapsed since the supply of the chemical solution M is started, the overflow valve 21 is closed, the chemical supply unit 11 is stopped, and the chemical valve 9 is closed. In addition, a drain valve 13 is opened to start discharging the chemical solution M by suction from the liquid supply/discharge port 8 in the bottom of the processing bath 1 (step 51).

The liquid discharge/vacuum suction unit 15 which is kept operated even after the chemical solution M in the processing bath 1 is completely discharged by suction draws a vacuum in the processing bath 1, thereby starting evacuation of the bath (step 52). The vacuum degree in the bath can be controlled by intermittently operating the liquid discharge/vacuum suction unit 15 or controlling the suction force of the unit 15.

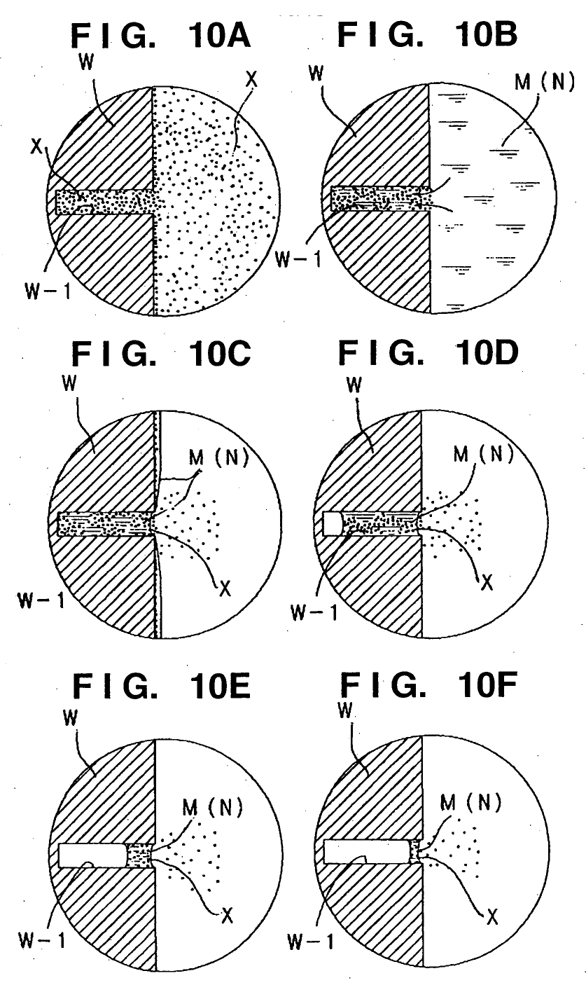

When the processing bath 1 is started to be evacuated, the chemical solution M mixed with the alcohol X in the depression W−1 gradually evaporates from the entrance of the depression W−1 (FIGS. 10C to 10F). In this case, the alcohol X having a higher vapor pressure preferentially evaporates.

When a predetermined time has elapsed since the evacuation of the processing bath 1 is started, the liquid discharge/vacuum suction unit 15 is stopped, and the drain valve 13 is closed. The flow then returns to step 49 to operate the alcohol supply unit 26 again and open the vapor valve 25. Consequently, the vaporized alcohol X is drawn into the evacuated processing bath 1 to form a vapor ambient of the alcohol X in the processing bath 1. The processing from step 49 to step 52 is repeated several times (N times).

When steps 49 to 52 are repeated a preset number of times (N times) and a processing time preset as the time for the chemical treatment of the substrate W has elapsed (YES in step 53), the liquid discharge/vacuum suction unit 15 is stopped, and the drain valve 13 is closed. In addition, a gas supply unit 19 is operated, and a gas valve 23 is opened. As a consequence, a gas is supplied from a gas supply port 18 into the processing bath 1 to return the internal pressure of the processing bath 1 to the atmospheric pressure (step 54).

When the internal pressure of the processing bath 1 is returned to the atmospheric pressure, the gas supply unit 19 is stopped, and the gas valve 23 is closed. Also, the lid 16 for closing the upper opening of the processing bath 1 is opened, and the substrates W are unloaded from the processing bath 1 (step 55).

When the washing process using the pure water N is to be subsequently executed after the chemical treatment of the substrate W by the chemical solution M is completed, the flow returns to step 49, and the alcohol valve 25 is opened to supply the vaporized alcohol X into the evacuated processing

Then, the alcohol valve 25 is closed, the overflow valve 21 is opened, a pure water supply unit 12 is operated, and a pure water valve 10 is opened. Consequently, the pure water N is supplied from the liquid supply/discharge port 8 into the processing bath 1 at a predetermined flow rate (m/s). After that, steps 49 to 52 are repeated several times (N times) by using the pure water N instead of the chemical solution M.

In the processing method of this embodiment, therefore, the chemical solution M or pure water N can be reliably supplied not only to the surface of the substrate W but also into the depression W−1, such as a small contact hole or deep pattern present in the surface and having a line width of 10 μm or less, by mixing the chemical solution M or pure water N with the alcohol X. In addition, low pressure drying in which a portion of the chemical solution M or pure water N entering the depression W−1 is gradually evaporated by drawing a vacuum in the processing bath 1 is repeated several times (N times). This allows the processing solution to move in the depression W−1. Consequently, it is possible to reliably and effectively perform the chemical treatment by which oxide films in the depression W−1 are etched away or the washing process by which the chemical solution and etching residue are washed away. Pores of a porous substrate can also be well cleaned.

After the surface of the substrate W and the inside of the depression W−1 are finally cleaned by using the pure water N by the processing method according to the second embodiment, a protective film F is favorably formed on the surface of the substrate W. The protective film F can be formed by the method explained in the first embodiment with reference to FIG. 4.

It is also possible to perform the series of cleaning processes such as the chemical treatment and washing process for the surface of the substrate W and the depression W−1 by combining the processing methods according to the first and second embodiments.

In this case, after the processing method according to the first embodiment is executed, the processing method according to the second embodiment is successively executed.

This cycle can be repeated in the processing bath 1 at a pressure lower than the atmospheric pressure.

Alternatively, the liquid contact step 44 explained in the second embodiment is performed, and, during the next liquid supply step 45, evacuation and pressurization of the processing bath 1 are repeated several times (N times) at a pressure lower than the atmospheric pressure as explained in the first embodiment. After that, the chemical solution M or pure water N is discharged from the processing bath 1, and the liquid evaporation step 46 by evacuation is executed as described in the second embodiment.

### Third Embodiment

The third embodiment of the processing system for performing the processing method of the present invention will be described below.

The processing system for performing this processing method has the same basic configuration as that of the processing system explained in detail in the first embodiment. Matters not particularly referred to in the third embodiment are the same as in the first embodiment.

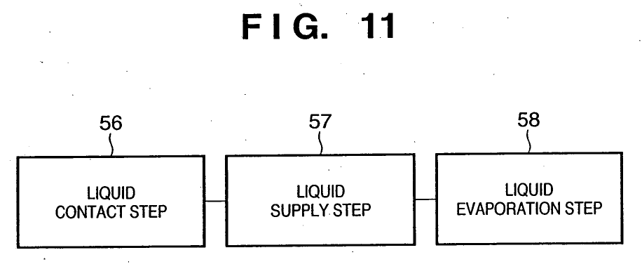

As shown in FIG. 11, the processing method of the third embodiment includes a liquid contact step 56, liquid supply step 57, and liquid evaporation step 58.

The liquid contact step 56, liquid supply step 57, and liquid evaporation step 58 are performed at least once, preferably, repeated several times. By this processing, a chemical treatment and/or a washing process can be reliably performed not only for the surface of a substrate W but also for various complicated depressions, such as trenches, contact holes, and deep patterns, having a line width of 10 μm or less and different depths. Likewise, pores of a porous substrate can also be reliably cleaned.

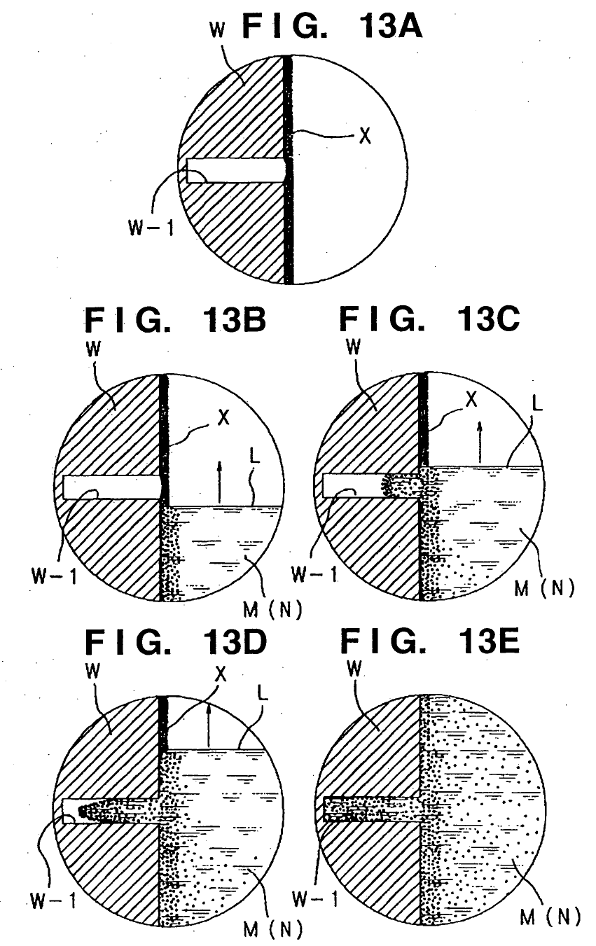

That is, a large kinetic energy is generated when a chemical solution M or pure water N comes in contact with alcohol X and dissolves together with the alcohol X. By using this kinetic energy, as shown in FIG. 13A, the alcohol X and the chemical solution M or pure water N are supplied into a depression W−1 against the surface tension of the alcohol X which is so condensed as to close the entrance of the depression W−1. In this manner, the depression W−1 is reliably subjected to the chemical treatment or washing process and cleaned (FIGS. 13B and 13C).

In the liquid contact step 56, the alcohol X such as isopropyl alcohol (IPA) is brought into contact with the surface of the substrate W and condensed on the surface so as to have a desired thickness.

In the liquid contact step 56, the alcohol X may not enter the depression W−1 because of the surface tension (contact angle) oh the surfaces of substrates W arranged either vertically or obliquely in a closed processing bath 1. That is, the alcohol X may be condensed so as to close the entrance of the depression W−1, thereby forming a condensed film on the entire surface of each substrate W.

Various methods are possible as a method of bringing the alcohol X into contact with the surface of the substrate W. For example, in the closed processing bath 1 in which substrates W are arranged parallel either vertically or obliquely, a vapor ambient of the alcohol X is formed, thereby bringing the alcohol X into contact with the surface of each substrate W and condensing the alcohol X on the surface. This method is desirably performed by making the internal pressure of the processing bath 1 lower than the atmospheric pressure.

In the liquid supply step 57, the chemical solution M or pure water N is supplied into the processing bath 1 from a liquid supply/discharge port 8 formed in the bottom of the processing bath 1, and a liquid level L of the chemical solution M or pure water N is raised at a predetermined rate. On the liquid level L, the chemical solution M or pure water N comes in contact with the alcohol X condensed on the surface of the substrate W in the liquid contact step 56, and a large kinetic energy is generated when the alcohol X and the chemical solution M or pure water N are mixed. By this kinetic energy, the alcohol X and the chemical solution M or pure water N are supplied into the depression W−1 against the surface tension of the alcohol X closing the entrance of the depression W−1.

In the liquid supply step 57, when the chemical solution M or pure water N is supplied into the processing bath 1 from the liquid supply/discharge port 8 in the bottom of the processing bath 1 and raised toward the upper portion of the processing bath 1, the rising rate of the liquid level L of the chemical solution M or pure water N is preferably set at 0.001 to 1.0 m/s.

If the liquid level rate is less than 0.001 m/s, the alcohol evaporates in contact with vapor of the vaporized chemical solution M or pure water N, before the liquid level L of the chemical solution M or pure water N supplied into the processing bath 1 evacuated to a pressure lower than the atmospheric pressure reaches the depression W−1 in the surface of the substrate W. This makes it meaningless to use alcohol to allow the chemical solution M or pure water N to enter a depression.

On the other hand, if the liquid level rate exceeds 1.0 m/s, a portion where the depression W−1 exists is dipped in the solution before the liquid level L of the chemical solution M or pure water N and the alcohol X come in contact with each other and mix. That is, since the rising rate of the liquid level is higher than the rate of the reaction between the alcohol X and the chemical solution M or pure water N, the portion where the depression W−1 exists is dipped in the chemical solution M or pure water N before the alcohol X and the chemical solution M or pure water N mix.

Accordingly, the liquid level rate of the chemical solution M or pure water N which rises after being supplied from the liquid supply/discharge port 8 in the bottom of the processing bath 1 is set at preferably 0.001 to 1.0 m/s, and more preferably, 0.01 to 0.05 m/s.

In the liquid evaporation step 58, the chemical solution M or pure water N is discharged from the processing bath 1 by suction. After that, a portion of the chemical solution M or pure water N mixed with the alcohol X in the depression W−1 is evaporated (volatilized) together with the alcohol X.

As a method of evaporating, together with the alcohol X, the chemical solution M or pure water N which mixes with the alcohol X when entering the trench W−1, it is preferable to, e.g., change the internal pressure of the processing bath 1 within a pressure range lower than the atmospheric pressure.

In this embodiment, the chemical solution M or pure water N is supplied into the depression W−1 in the liquid supply step 57 and evaporated by repeating evacuation and pressurization of the processing bath 1. Since this causes reciprocal motion of the liquid in the depression W−1, the chemical treatment and/or the washing process can be reliably performed for the depression W−1. Accordingly, this method can reliably and efficiently clean the inside of the depression W−1 as well as the surface of the substrate W.

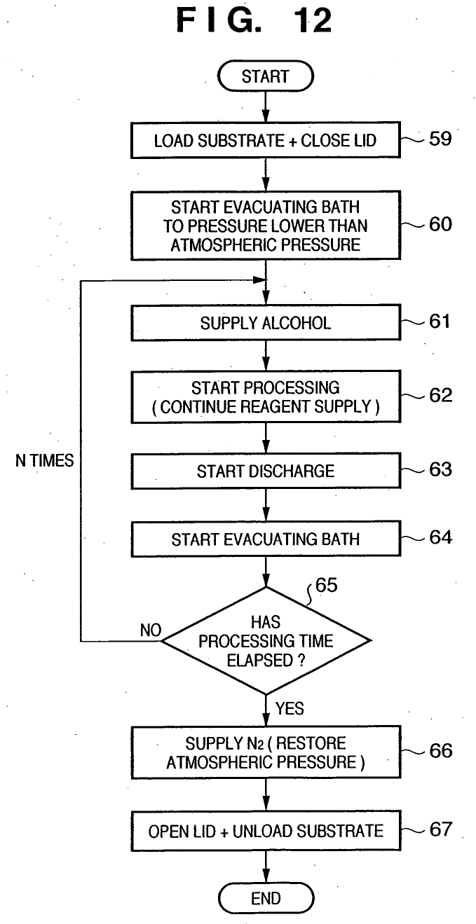

The processing method according to the third embodiment will be described below with reference to a flow chart shown in FIG. 12.

Substrates W are arranged parallel either vertically or obliquely in the processing bath and a lid 16 is closed (step 59).

After the lid 16 is closed, a liquid discharge/vacuum suction unit 15 is operated, and a suction valve 22 is opened to start the process of evacuating the processing bath 1 to a pressure, e.g., 10 to 99 kPa, lower than the atmospheric pressure (step 60).

When the internal pressure of the processing bath 1 is reduced to the target pressure value within the range of 10 to 99 kPa, the suction valve 22 is closed. After that, an alcohol supply unit 26 is operated, and an alcohol valve 25 is opened. Consequently, vapor of the alcohol X generated by the alcohol supply unit 26 is supplied through a vapor supply line 7 and drawn into the processing bath 1 from a vapor supply port 24 in a side wall in the upper portion of the processing bath 1 (step 61). This forms a vapor ambient filled with the vapor of the alcohol X in the processing bath 1.

This supply of the alcohol X can be stopped when the vapor ambient is formed in the processing bath 1, or can be continued until the alcohol X is condensed on the surface of the substrate W by a temperature difference produced by contact with the surface.

When the alcohol X is condensed on the surface of the substrate W (in practice, when a time previously determined on the basis of experimental results and the like has elapsed), the alcohol valve 25 is closed, an overflow valve 21 is opened, a chemical supply unit 11 is operated, and a chemical valve 9 is opened. As a consequence, the chemical solution M is supplied from the liquid supply/discharge port 8 into the processing bath 1. The supply rate of the chemical solution M is so controlled that the liquid level L of the chemical solution M rises from the bottom of the processing bath 1 at a rate of 0.001 to 1.0 m/s.

When the supply of the chemical solution M into the processing bath 1 is started, the liquid level L of the chemical solution M rises in contact with the surface of the substrate W. The chemical solution M rising in the processing bath 1 overflows from an overflow port 20 and is discharged through the overflow valve 21. By using the chemical solution M, the chemical treatment by which oxide films, contaminants, and the like on the substrate W are etched away with the chemical solution M is performed (step 62).

In this chemical treatment, as shown in FIGS. 13B and 13C, the liquid level L of the chemical solution M rising from the bottom of the processing bath 1 comes in contact with the alcohol X condensed on (adhered to) the surface of the substrate W, and kinetic energy is generated when the chemical solution M and alcohol X are mixed. By this kinetic energy, the alcohol X and chemical solution M mix and enter the depression W−1 against the surface tension of the alcohol X closing the entrance of the depression W−1. As a consequence, the inside of the depression W−1 is etched simultaneously with the surface of the substrate W.

When a predetermined time has elapsed since the chemical treatment using the chemical solution M is started, the chemical supply unit 11 is stopped, and the chemical valve 9 is closed. In addition, a drain valve 13 is opened to start discharging the chemical solution M by suction from the liquid supply/discharge port 8 in the bottom of the processing bath 1 (step 63).

The liquid discharge/vacuum suction unit 15 which is ‘kept ’ operated even after the chemical solution M in the processing bath 1 is completely discharged by suction draws a vacuum in the processing bath 1, thereby starting evacuation of the bath (step 64). The vacuum degree in the bath can be controlled by intermittently operating the liquid discharge/vacuum suction unit 15 or controlling the suction force of the unit 15.

When the processing bath 1 is started to be evacuated, the chemical solution M mixing with the alcohol X and entering the depression W−1 gradually evaporates from the entrance of the depression W−1 (FIGS. 10C to 10F). In this case, the alcohol X having a higher vapor pressure preferentially evaporates.

When a predetermined time has elapsed since the evacuation of the processing bath 1 is started, the liquid discharge/vacuum suction unit 15 is stopped, and the drain valve 13 is closed. The alcohol supply unit 26 is operated again, and the vapor valve 25 is opened. Accordingly, the vaporized alcohol X is drawn into the evacuated processing bath 1 to form a vapor ambient of the alcohol X in the processing bath 1. Steps 61 to 64 are repeated several times (N times).

When steps 61 to 64 are repeated a preset number of times (N times) and a processing time preset as the time for the chemical treatment of the substrate W has elapsed (YES in step 65), the liquid discharge/vacuum suction unit 15 is stopped, and the drain valve 13 is closed. In addition, a gas supply unit 19 is operated, and a gas valve 23 is opened. As a consequence, a gas is supplied from a gas supply port 18 into the processing bath 1 to return the internal pressure of the processing bath 1 to the atmospheric pressure (step 66).

When the internal pressure of the processing bath 1 is returned to the atmospheric pressure, the gas supply unit 19 is stopped, and the gas valve 23 is closed. Also, the lid 16 for closing the upper opening of the processing bath 1 is opened, and the substrates W are unloaded from the processing bath 1 (step 67).

When the washing process using the pure water N is to be subsequently executed after the chemical treatment of the substrate W by the chemical solution M is completed, the flow returns to step 61, and the alcohol valve 25 is opened to supply the alcohol X into the evacuated processing bath 1.

Then, the alcohol valve 25 is closed, the overflow valve 21 is opened, a pure water supply unit 12 is operated, and a pure water valve 10 is opened. Consequently, the pure water N is supplied from the liquid supply/discharge port 8 into the processing bath 1 such that the liquid level rate is 0.001 to 1.0 m/s. After that, steps 61 to 64 are repeated several times (N times) by using the pure water N instead of the chemical solution M.

In the processing method of this embodiment, therefore, the surface tension of the alcohol X which not only covers the surface of the substrate W but also closes the entrance of the depression W−1, such as a contact hole or deep pattern present in the surface and having a line width of 10 μm or less, can be broken by using the kinetic energy generated by mixing of the chemical solution M or pure water N and the alcohol X. Accordingly, the chemical solution M mixed with the alcohol X can be reliably supplied into the depression W−1. After that, evacuation by which a portion of the chemical solution M entering the depression W−1 is gradually evaporated by evacuating the processing bath 1 is repeated several times (N times). This allows the processing solution to move in the depression W−1. This makes it possible to reliably and effectively perform the chemical treatment by which oxide films in the depression W−1 are etched away or the washing process by which the chemical solution and etching residue are washed away. Pores of a porous substrate can also be well cleaned.

After the surface of the substrate W and the inside of the depression W−1 are finally cleaned by using the pure water N by the processing method according to the third embodiment, a protective film F is favorably formed on the surface of the substrate W. The protective film F can be formed by the method explained in the first embodiment with reference to FIG. 4.

During the liquid supply step 57 after the liquid contact step 56 is performed, evacuation and pressurization of the processing bath 1 can be repeated several times (N times) at a pressure lower than the atmospheric pressure as explained in the first embodiment. After that, while the chemical solution M or pure water N is discharged from the processing bath 1 by suction and the liquid evaporation step 58 explained in the third embodiment is executed, the series of cleaning processes such as the chemical treatment and washing process for the surface of the substrate W and the depression W−1 can be performed.

In the second and third embodiments, in the liquid supply steps 45 and 57 the chemical treatment or washing process is performed for the surface of the substrate W and the depression W−1 while the chemical solution M or pure water N is continuously supplied. However, if the processing time is short, the supply of the chemical solution M or pure water N is temporarily stopped when the liquid level L of the chemical solution M or pure water N supplied from the bottom of the processing bath 1 has reached a water level at which the substrate W is completely dipped, and the processing bath 1 is further evacuated at a pressure lower than the atmospheric pressure and then pressurized. This processing can be repeated several times (N times).

The processing bath 1 described above has a single-bath structure. However, the processing bath 1 may also have a double-bath structure including an inner bath in which substrates W are arranged parallel either vertically or obliquely, and an outer bath having the lid 16. Alternatively, it is possible to use a triple-bath structure including an inner bath as described above, an intermediate bath formed outside the inner bath, and an outer bath formed outside the intermediate bath and having a lid. A four-bath or five-bath structure is also possible. That is, the bath structure can take any form as long as the space in which the substrate W is placed can be closed and the internal pressure of this closed space can be controlled.

For example, when a processing bath having a double-bath structure is used, the liquid supply/discharge port 8 is formed in the bottom of the inner bath, and the chemical solution M or pure water N is continuously supplied from the liquid supply/discharge port 8 so as to form a rising flow in this inner bath. The chemical solution M or pure water N is allowed to overflow from the upper opening of the inner bath into the outer bath, and discharged outside the bath from a drain hole formed in the bottom of the outer bath.

The usefulness of the preferred embodiments of the present invention will be explained below.

In the preferred embodiments of the present invention, evacuation and pressurization of the processing bath are repeated at a pressure lower than the atmospheric pressure. Therefore, a processing solution entering a depression is pushed outside the depression by expansion of an air bubble in the depression upon evacuation, and the processing solution enters the depression by compression of the air bubble upon pressurization. This causes reciprocal motion of the processing solution in the depression, so the inside of the depression is reliably processed.

Accordingly, the processing solution can be reliably supplied not only to the surface of a substrate but also to a plurality of various depressions present in the surface and having a line width of 10 μm or less and different depths, and can be reciprocated. Consequently, it is possible to reliably and effectively perform a series of cleaning processes from a chemical treatment by which oxide films and the like in the depressions are etched away to a washing process by which deposits such as the chemical solution and etching residue in the depressions are washed away. That is, in the preferred embodiments of the present invention, it is possible to well perform the cleaning processes regarded as important in the fabrication process of high-performance, highly integrated semiconductor devices.

Also, in the preferred embodiments of the present invention, in the liquid contact step, alcohol can be supplied not only to the surface of a substrate but also to various complicated depressions such as trenches present in the surface and having a line width of 10 μm or less and different depths. In the liquid supply step performed after that, a processing solution such as a chemical solution or pure water supplied into a processing bath can be reliably supplied into the depressions by mixing the processing solution with the alcohol. After that, in the liquid evaporation step a portion of the processing solution supplied into the depressions is evaporated by evacuating the processing bath. By repeating this processing, the processing solution can be reciprocated in each depression. This makes it possible to reliably and efficiently perform the series of cleaning processes from the chemical treatment by which oxide films and the like in the depression are etched away to the washing process by which deposits such as the chemical solution and etching residue are washed away from the depression.

In the preferred embodiments of the present invention, alcohol is condensed on the surface of a substrate in the liquid contact step, and, when a processing solution is supplied in the liquid supply step performed after that, a large kinetic energy is generated upon mixing of the processing solution and alcohol. By this kinetic energy, the processing solution can be reliably supplied into a fine depression as described above against the surface tension of the alcohol closing the entrance of the depression. In the liquid evaporation step performed after that, a portion of the processing solution supplied into the depression is evaporated by evacuating the processing bath. By repeating this processing, the processing solution such as a chemical solution or pure water is reciprocated in the depression. This makes it possible to reliably and efficiently perform the series of cleaning processes from the chemical treatment by which oxide films and the like in the depression are etched away to the washing process by which deposits such as the chemical solution and etching residue in the trench are washed away.

In the preferred embodiments of the present invention, therefore, trenches, contact holes, deep patterns, and pores of a porous substrate having a dimension of 10 μm or less can be reliably processed (by, e.g., a chemical treatment and washing process) as well as the surface of a substrate to be processed. That is, it is possible to perform those processes such as cleaning of depressions, e.g., contact holes, deep patterns, and trenches, and pores of a porous substrate, which are regarded as important in the fabrication process of high-performance highly integrated semiconductor devices.

Furthermore, in the preferred embodiments of the present invention, the substrate surface is activated by the low pressure drying process performed after cleaning. A protective film of pure water can be formed on the surface of the substrate by adsorption occurring on the surface upon its activation. By forming this protective film on the cleaned substrate, the clean surface of the substrate is protected even when the substrate is exposed to the atmosphere in, e.g., a clean room. That is, adsorption of contaminated atmospheric water (including organic contamination and the like) in the surface of the substrate can be prevented. In other words, the surface of the substrate can be maintained clean even after the substrate is unloaded from the processing bath.

The present invention can provide a substrate processing method and substrate processing apparatus suited to reliably and stably processing a substrate having depressions.

As many apparently widely different embodiments of the present invention can be made without departing from the spirit and scope thereof, it is to be understood that the invention is not limited to the specific embodiments thereof except as defined in the appended claims.

1-7. (canceled)

8. A substrate processing method comprising:
an alcohol supply step of supplying alcohol to a substrate having a depression;
a processing solution supply step of supplying a processing solution to the substrate, and allowing the processing solution to enter the depression; and
an evaporation step of evaporating the alcohol and at least a portion of the processing solution in the depression,
wherein a cycle including the alcohol supply step, processing solution supply step, and evaporation step is repetitively performed a plurality of times.

9. The method according to claim 8, wherein the alcohol supply step, processing solution supply step, and evaporation step are performed by placing a substrate to be processed in a closed processing bath.

10. The method according to claim 9, further comprising, after the processing solution supply step and before the evaporation step, a discharge step of discharging the processing solution from the processing bath.

11. The method according to claim 8, wherein the processing solution supply step comprises supplying the processing solution to the processing bath such that a liquid level of the processing solution in the processing bath containing the substrate rises across a surface of the substrate.

12. The method according to claim 11, wherein the processing solution supply step comprises supplying the processing solution to the processing bath such that the liquid level of the processing solution rises at a rate of 0.001 to 1.0 m/s.

13. The method according to claim 8, wherein the alcohol supply step, processing solution supply step, and evaporation step are performed at a pressure lower than the atmospheric pressure.

14. The method according to claim 9, further comprising a protective film formation step of forming a protective film on a processed substrate before the substrate is unloaded from the processing bath.

15. The method according to claim 14, wherein the protective film is made of pure water.

16-22. (canceled)
